(19) United States
(12) Patent Application Publication
(10) Pub. No.: US 2007/0196359 A1
(43) Pub. Date: Aug. 23, 2007

(54) Halosuccinimide biocide

(75) Inventors: Bert Walter, Mendota Heights, MN (US); Patricia M. Stanley, Minneapolis, MN (US); John J. Matta, Shoreview, MN (US)

Correspondence Address: FAEGRE & BENSON;ATTN: PATENT DOCKETING, 2200 WELLS FARGO CENTER, 90 SOUTH SEVENTH STREET, MINNEAPOLIS, MN, 55402-3901, US

(73) Assignee: Minntech Corporation, Minneapolis, MN (US)

(21) Appl. No.: 11/360,067

(22) Filed: Feb. 23, 2006

(51) Int. Cl. A01N 43/80; A01N 43/38; A01N 57/10; A01N 25/00

(52) U.S. Cl. 424/126; 514/425; 514/109; 514/373; 514/417

(57) ABSTRACT

The present invention relates to biocides. More particularly, the present invention relates to a novel solution that is an effective high level disinfectant biocide. The present invention biocide includes a halide substituted N-succinimide in an aqueous solution in the pH range of 2-6. The biocide also includes N-succinimide as a stabilizer. In some embodiments the biocide may further include an anti-corrosive agent.

### FIELD OF THE INVENTION

The present invention relates to biocides. More particularly, the present invention relates to a halide substituted N-succinimide solution in an acidic pH range that is an effective high level disinfectant.

### BACKGROUND OF THE INVENTION

A biocide is a chemical substance capable of killing different forms of living organisms. Examples of biocides include pesticides, fungicides, herbicides, insecticides, miticides, or rodenticides. In particular, biocides can be used to prevent or protect against biological infestation and growth and to disinfect surfaces, instruments, etc. For example, certain types of materials can be added to pool water or industrial water systems to act as an algicide. In other cases, articles, such as medical devices, can be disinfected. For disinfection, desirable characteristics may include rapid effectiveness against bacterial spores, mycobacteria, vegetative bacteria, viruses, in addition to other undesirable organisms, such as fungi.

Known biocides used to disinfect medical devices may include aldehydes or dialdehydes such as formaldehyde, glutaraldehyde, or o-phthaldehyde (also known as OPA) and peroxy acid compounds such as peracetic acid. Unfortunately, many of these materials have undesirable properties. Formaldehyde is potentially carcinogenic and has an objectionable odor. Glutaraldehyde also has an objectionable odor and may be volatile and chemically unstable during storage. OPA may undesirably stain certain surfaces black, such as skin, hair, clothing, gloves and other materials.

Typically, many solid compounds having biocidal activity are used in solution by dissolving them into suitable liquids, for example, glycols, glycol ethers, aprotic polar solvents, water, or a mixture of these solvents with water. Liquidizing biocidal solid compounds in this manner provides these compounds with excellent workability at the time of use. However, when certain biocides are prepared as liquid solutions a volume of irritant corrosive gas may be generated. Further, the biocidal active ingredients may be deactivated within a very short period of time.

There is therefore a continual need for effective agents with biocidal properties.

### BRIEF SUMMARY OF THE INVENTION

One embodiment of the present invention includes an aqueous biocide composition wherein the composition includes an N-halosuccinimide or derivative thereof, a succinimide or a derivative thereof, an anticorrosive agent, and an aqueous carrier, wherein the aqueous composition has a pH in the range of less than about 6.

In one embodiment of the present invention the biocide may be an N-halosuccinimide of the formula: 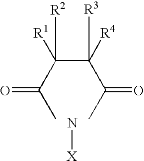
wherein:
X is a halide such as chlorine, bromine, or iodine;
R1, R2, R3 and R4, alone or together, are a hydrogen, a methyl group, or an alkyl group such as CH3-(CH2)n; and
n is an integer between one and eight.

In a further embodiment of the present invention the N-halosuccinimide may be a substituted or unsubstituted aromatic ring structure that forms the structure: 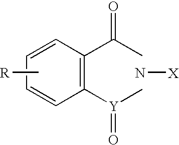
wherein:
X is a halide such as chlorine, bromine, or iodine;
Y is a carbon atom (C), SO or PO2; and
R may include a nitro, sulfur or phosphor group.

The biocide composition may be an N-chlorosuccinimide or the N-bromosuccinimide compound or a derivative thereof.

In still further embodiments the biocide composition may include 0.1 to 3% of the N-halosuccinimide composition.

The biocide composition may further include a stabilizer of succinimide or a derivative thereof wherein the stabilizer comprises approximately 0.2 -10% of the overall composition.

In further embodiments the biocide composition may include an anticorrosive selected from the group consisting of triazoles, alkylamines, and ethoxylates.

In further embodiments the anticorrosive agent may be 0.01-1% of the composition.

In still further embodiments the pH may be in the range of about 2 to about 6.

In still further embodiments the biocide composition may include one or more of the group consisting of surfactants, cosolvents, colorants, odorants, and buffers.

Still further embodiments of the present invention include a method of sterilizing a surface by contacting a surface with a biocide composition for a time to sufficient to kill 10⁶ mycobacteria and/or 10⁶ bacterial endospores and rinsing the surface to remove residual biocide composition.

While multiple embodiments are disclosed, still other embodiments of the present invention will become apparent to those skilled in the art from the following detailed description, which shows and describes illustrative embodiments of the invention. The present invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a graph illustrating the efficacy of an embodiment of the present invention against bacterial endospores.

FIG. 2 is a graph illustrating the efficacy of an embodiment of the present invention against mycobacteria.

FIG. 3 is a graph illustrating the stability of an embodiment of the present invention over time and with varying concentrations of succinimide added.

FIG. 4 is a graph illustrating the corrosion rate of an embodiment of the present invention versus pH level.

FIG. 5 is a graph illustrating the corrosion rate of an embodiment of the present invention with varying concentrations of succinimide added.

FIG. 6 is a graph illustrating the corrosion rate of an embodiment of the present invention with varying levels and types of anticorrosive agents added.

### DETAILED DESCRIPTION

The present invention relates generally to a novel biocide that can be used to formulate a high level disinfection (HLD) material. The biocide may be provided as a solution that is generally odorless and non-staining. The biocide may be utilized to sterilize or disinfect surfaces, medical devices, fermentors and clean rooms. Medical devices that may be sterilized or disinfected may include endoscopes, hemodialysis equipment, dental equipment, and inhalation equipment. The present composition may also be useful in other sterilization and disinfection solutions and methods and may be used to sterilize other surfaces and medical devices.

One embodiment of the present invention biocide composition generally includes a halide substituted N-succinimide (also described in this specification as an N-halosuccinimide) in addition to a stabilizer, an anticorrosive agent, and an aqueous carrier.

The N-succinimide may be of the following general formula: 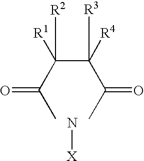
wherein:
X represents a halogen atom;
R1, R2, R3, and R4, alone or together, represent a hydrogen, an alkyl group such as CH3-(CH2)n; and
n is 0-8, an aromatic ring, a cyclopentane or a cyclohexane.

Another example of the halide substituted N-succinimide may be, for example: 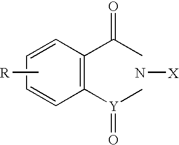
wherein:
X represents a halogen atom; and
Y represents C, SO, or PO2.
   In addition, R may include a nitro, sulfo or phospho group (SO4, NO2, or PO4).

The halide substituted N-succinimide may be used as a liquid biocide, and, in particular, as a microbicide. In one embodiment, the N-halosuccinimide of the biocide may be N-bromosuccinimide (NBS) and may be provided in an aqueous solution wherein the NBS is in the range of about 0.1% to about 2.8% by weight (all percentages herein being by weight unless otherwise specified). In further embodiments the NBS may be in the range of about 0.5 to 1.5% and up to about 3%, if acetic acid buffer is used due to an increase in the solubility of NBS in the buffered solution. In another embodiment the N-halosuccinimide may be N-chlorosuccinimide (NCS) and may be provided in an aqueous solution in the range of about 0.1% to about 1.8%. In further embodiments the NCS may be in the range of about 0.5 to about 1.5%. The aqueous biocide solution that results from the addition of the halide substituted N-succinimide may have a pH between approximately 2 and 6. In further embodiments the pH may be adjusted as desired. In addition, the percent of the N-succinimide in the biocide solution may also be increased or decreased as desired.

In one embodiment the stabilizer may be added to push the equilibrium of the N-succinimide in the biocide solution towards the bound oxy-halide. The stabilizer may include succinimide added to the biocide solution at approximately 1% to 10.0%. In other embodiments the stabilizer may be added in a greater or lesser amount depending on the stabilization needs and the stabilizer material. Other stabilizers may include, for example, hydantoins, alkyl or aryl sulfamides such as toluenesulfamide, benzamide, methanesulfamide and urea, thiophenes, indoles or sodium diacetate.

In one embodiment the anticorrosive agent may be added to the biocide solution such that it represents about 0.01 to about 1% of the biocide solution. One useful anticorrosive agent may be benzotriazole, which may be added to the biocide solution at about 0.01% to about 0.5%. Another class of useful anticorrosive agents may be the Mazon RI corrosion inhibitors (BASF), such as Mazon RI 246, which may be added to the biocide solution at about 0.04% to 0.5%. Another useful anticorrosive agent may be sodium ethoxylate, which may be added to the biocide solution at about 0.1% to 0.5%.

In still further embodiments a buffer may be added to the biocide solution. Suitable buffers include acetate, phosphate, citrate and Good Buffers such as MOPS, MES, HEPES, PIPES, and EPPS. See N. E. GOOD et al., Biochemistry 5 467-477 (1966) and W. J. Ferguson et al., Analytical Biochemistry 104 300-310 (1980).

One embodiment of the aqueous biocide solution of the present invention biocide may include:

| Ingredient | Weight % |
|---|---|
| N-Halosuccinimide | 1.5 |
| Succinimide | 5.0 |
| Benzotriazole | 0.3 |
| Acetate buffer | 20% |

The resultant pH of this biocide solution is approximately 3. The mixture is prepared by preparing an acetate buffer at pH 3 and then dissolving each of the other components to the specified concentrations.

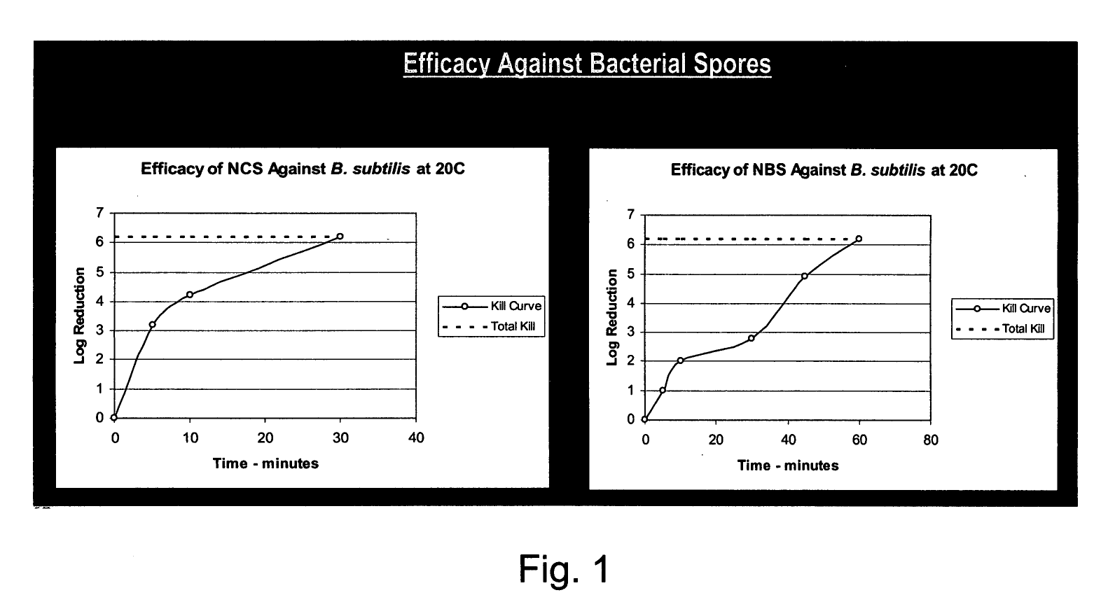

As illustrated in FIG. 1, two embodiments of the present invention, including NCS and NBS, were tested for efficacy against B. subtilis bacterial spores at 20° C. The NCS biocide solution included about 1% NCS and was buffered at a pH of about 4. The NBS biocide solution included about 1% NBS and was buffered at pH about 3. As illustrated, it was found that both the NBS and NCS resulted in a total kill corresponding to a 6 log reduction in the bacteria, representing a million fold decrease. In the case of NCS, a total kill corresponding to a 6 log reduction occurred over a period of approximately 30 minutes. In the case of NBS, a total kill corresponding to a 6 log reduction occurred over a period of approximately 60 minutes.

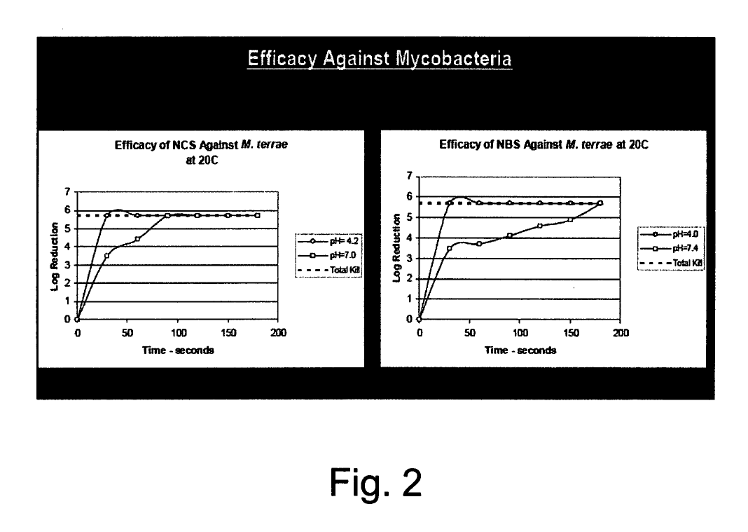

As illustrated in FIG. 2, NBS and NCS were tested against M. terrae mycobacteria. The NCS biocide solution included about 1% NCS, was buffered at a pH of about 4 and was tested at 20° C. The NBS biocide solution included about 1% NBS, was buffered at a pH of about 3 and was tested at 20° C. Each solution produced a total kill corresponding to a 6 log reduction of the mycobacteria. Both NCS and NBS demonstrated a total kill in about 30 seconds. At pH 7.4, NBS demonstrated a total kill of mycobacteria in about 175 seconds and NCS demonstrated a total kill of mycobacteria in about 90 seconds.

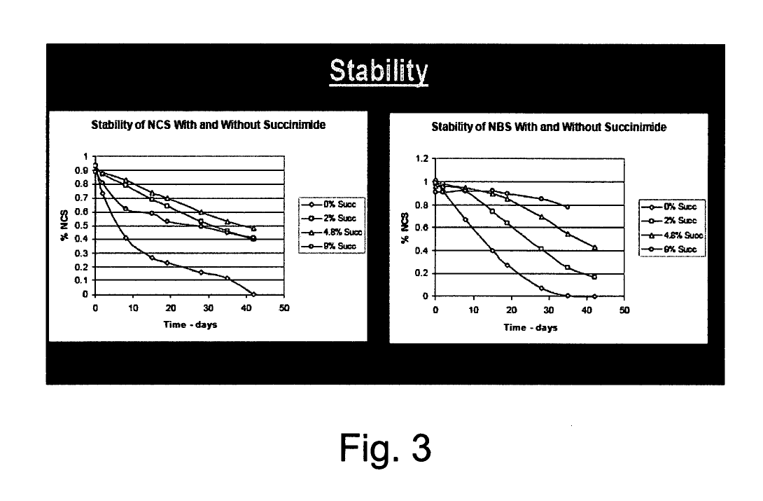

As illustrated in FIG. 3, it was found that the biocide made with halide substituted N-succinimide lost potency over time by a reduction of the amount of the active ingredient as determined by an iodometric titration. The addition of N-succinimide, however, resulted in improved retention of the active ingredient, halide substituted N-succinimide, over time. NCS demonstrated improved stability compared to NCS alone when 4.8% succinimide was added to the biocide solution. NBS also demonstrated improved stability over time when increasing amounts of succinimide was added, with the best results occurring when 9.0% was added to the biocide solution. The NBS biocide solution included about 1.0% NBS, 0.19% surfactant L-44 and was at a pH of about 3. The NCS biocide solution included about 1.0% NCS, 0.19% surfactant and was at a pH of about 3.

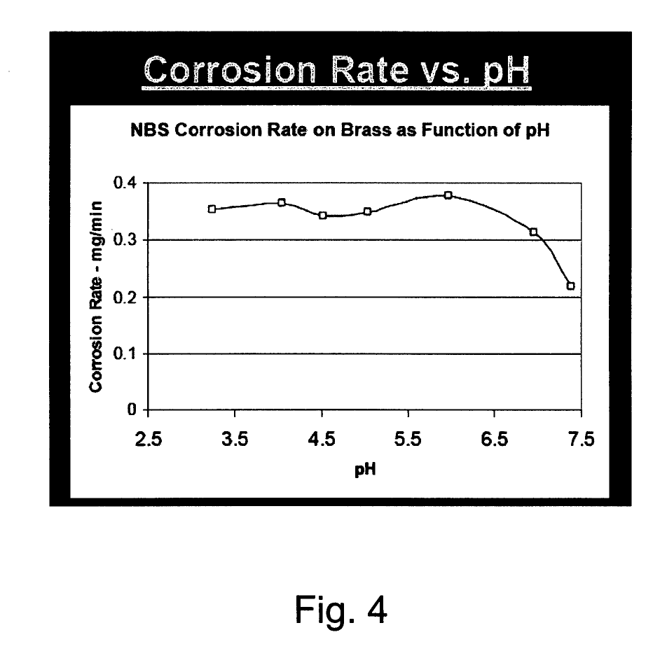

As illustrated in FIG. 4, the corrosion rate of brass in mg/min when exposed to the biocide solution stayed between about 0.3 and about 0.4 from a pH of about 3 to about 7. The testing was conducted at 25° C. using brass coupons according to ASTM standard G31-72 (04) guidelines for corrosion testing. The biocide solutions included about 1.0% NBS and were buffered to different pH values in the range of about 3 to about 7. Brass was used as the test material since it is most susceptible to corrosion in the acid pH range. The observed corrosion rate was about three fold the rate usually observed for water alone.

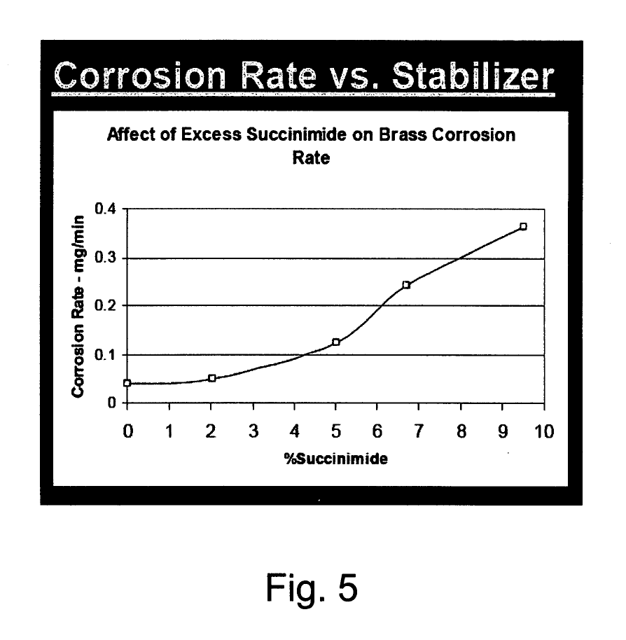

Further testing on the corrosion rate of brass was also performed with the addition of succinimide as a stabilizer. The succinimide stabilizer was added in different amounts between 0.0% and 9.5% and the tests were again run at 25° C. according to ASTM standard G31-72 (04) guidelines. The results are shown in FIG. 5. As illustrated, as the percent of excess succinimide was increased, the corrosion rate at a given pH (3) also increased. The biocide solutions tested were of increasing succinimide between about 0.0% and 9.5%.

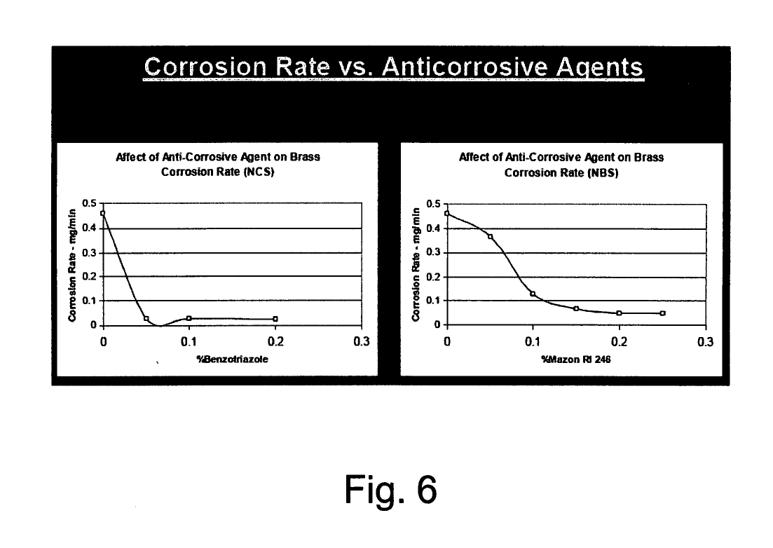

Additional testing was performed on the corrosion rate of embodiments of the present invention with the addition of anticorrosive agents. As illustrated in FIG. 6, the addition of increasing amounts of benzotriazole (0.0-0.2%) to a series of 1% NCS biocide solutions resulted in a decreased corrosion rate. The corrosion rate of NCS alone was approximately 0.48 mg/min but decreased to approximately 0.02 mg/min with the addition of 0.2% benzotriazole. The corrosion rates as a function of benzotriazole are summarized in Table 1.

TABLE 1

| % Benzotriazole | Corrosion Rate (mg/min) |
|---|---|
| 0 | 0.48 |
| 0.05 | 0.02 |
| 0.1 | 0.02 |
| 0.2 | 0.02 |

As is also shown in FIG. 6, the addition of Mazon RI 246 to NBS had a significant positive impact on the overall corrosion rate of the biocide material. The corrosion rate of NBS alone was approximately 0.48 mg/min but decreased to approximately 0.05 mg/min with the addition of 0.2% Mazon RI 246. The corrosion rates as a function of Mazon RI 246 are summarized in Table 2.

TABLE 2

| % Mazon RI 246 | Corrosion Rate (mg/min) |
|---|---|
| 0 | 0.48 |
| 0.05 | 0.38 |
| 0.10 | 0.12 |
| 0.15 | 0.08 |
| 0.20 | 0.05 |
| 0.25 | 0.05 |

Various modifications and additions can be made to the exemplary embodiments discussed without departing from the scope of the present invention. Accordingly, the scope of the present invention is intended to embrace all such alternatives, modifications, and variations as fall within the scope of the claims, together with all equivalents thereof.

1. An aqueous biocide composition comprising
a) an N-halosuccinimide or derivative thereof;
b) a succinimide or a derivative thereof;
c) an anticorrosive agent; and
d) an aqueous carrier having a pH less than about 6.

2. The biocide composition of claim 1 wherein the N-halosuccinimide is a compound of the formula: 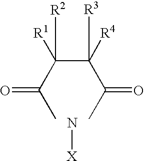
where:
X is Cl, Br or I;
R1, R2, R3 and R4, alone or together are hydrogen, CH3-, CH3-(CH2)n-, or an aromatic ring; and
n is 1-8.

3. The biocide composition of claim 2 wherein the N-halosuccinimide forms a compound of the formula: 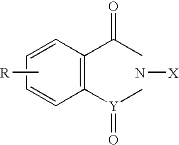
where:
Y is C, SO or PO2;
the aromatic ring can be further substituted by R; and
R is a nitro, sulfo, or phospho group.

4. The biocide composition of claim 1 wherein the N-halosuccinimide is a compound of the formula: 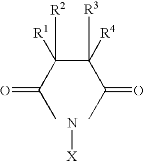
where:
X is Cl, Br or I; and
R1, R2, R3 and R4 are hydrogen.

5. The biocide composition of claim 1 wherein the N-halosuccinimide is the N-chlorosuccinimide or the N-bromosuccinimide.

6. The biocide composition of claim 1 wherein the N-halosuccinimide comprises 0.1 to 3% of the composition.

7. The biocide composition of claim 1 wherein the succinimide or derivative thereof is a compound of the formula: 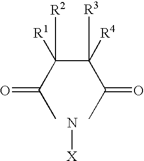
where:
X and R1-R4 are hydrogen, CH3-, CH3-(CH2)n-, or a substituted or unsubstituted aromatic ring; and
n is 1-8.

8. The biocide composition of claim 1 wherein the succinimide or derivative thereof is succinimide.

9. The biocide composition of claim 1 wherein the succinimide or derivative thereof comprises approximately 0.1-10% of the composition.

10. The biocide composition of claim 1 wherein the anticorrosive agent is effective to inhibit metal corrosion.

11. The biocide composition of claim 1 wherein the anticorrosive agent is selected from the group consisting of triazoles, alkylamines, and ethoxylates.

12. The biocide composition of claim 1 wherein the anticorrosive agent comprises 0.01-1% of the composition.

13. The biocide composition of claim 1 wherein the aqueous carrier has a pH in the range of about 2 to about 6.

14. The biocide composition of claim 1 further comprising additional additives.

15. The biocide composition of claim 1 further comprising one or more of the group consisting of surfactants, cosolvents, colorants, odorants, and buffers.

16. The biocide composition of claim 1 further comprising a buffer.

17. A method of sterilizing a surface comprising
a) contacting a surface with a biocide composition for a time sufficient to totally kill 10⁶ microbial endospores, the composition including an N-halosuccinimide or derivative thereof, a succinimide or a derivative thereof, an anticorrosive agent, and an aqueous carrier having a pH less than about 6, and
b) rinsing the surface to remove residual biocide composition.

18. The method of claim 17 wherein contacting the surface comprises contacting the surface of a medical device.

19. The method of claim 17 wherein the contacting the surface comprises contacting the surface for about 30-600 seconds.

20. The method of claim 17 wherein contacting the surface comprises contacting the surface for about 15-240 minutes.

21. A method of stabilizing a N-halosuccinimide in an acidic aqueous composition comprising adding an effect amount of succinimide or derivative thereof to the aqueous composition.

22. The method of claim 21 wherein the effective amount of succinimide or a derivative thereof in a range of 0.1-10% of the composition.

23. The method of claim 1 wherein succinimide is added to the aqueous composition.

24. A method of making an aqueous biocide composition comprising the steps of:
a) preparing an acetate buffer of approximately pH 3;
b) adding halosuccinimide whereby the halosuccinimide is about 1.5% of the composition;
c) adding succinimide to whereby the succinimide is about 9% of the composition; and
d) adding anti-corrosive agent whereby the anti-corrosive agent is about 0.5% of the concentration.
